(19) United States
(12) Patent Application Publication
(10) Pub. No.: US 2014/0352291 A1
(43) Pub. Date: Dec. 4, 2014

(54) HYDRAULIC TORQUE CONVERTER WITH AUTOMATIC REGULATOR OF DYNAMIC LIQUID TEMPERATURE

(71) Applicant: Suhong Chen, Chongqing (CN)

(72) Inventor: Suhong Chen, Chongqing (CN)

(21) Appl. No.: 13/905,934

(22) Filed: May 30, 2013

(51) Int. Cl. F16H 59/78; F16H 47/06; F28F 27/02

(52) U.S. Cl. CPC F16H 59/78; F28F 27/02; F16H 47/06
USPC 60/431

(57) ABSTRACT

The hydraulic torque converter with a temperature automatic regulator of dynamic liquid includes hydraulic torque converter and radiator. A temperature control valve is also included to reflect the temperature of the dynamic liquid. The hydraulic torque converter is provided with dynamic liquid outlet tube and dynamic liquid inlet tube. The dynamic liquid inlet tube and dynamic liquid outlet tube are connected with radiator. The temperature control valve is mounted at the end of dynamic liquid inlet tube and dynamic liquid outlet tube near the hydraulic torque converter.

### FIELD OF THE INVENTION

The present invention in general relates to a torque converter, and in particular to hydraulic torque converter of vehicle transmission gear.

### BACKGROUND OF THE INVENTION

The hydraulic torque converter is an automobile transmission gear by using dynamic liquid to drive and regulate torque. During the operation, temperature of the dynamic liquid may rise so as to affect torque transmission and output of the hydraulic torque converter. Therefore, when temperature of the hydraulic liquid rises during the operation, it is necessary to transmit the dynamic liquid to the heat exchanger to decrease temperature of the dynamic liquid. The existing technology, as for example detailed in U.S. Pat. No. 7,487,826 B2 “Bypass valve and heat exchanger” introduced a heat exchanger with bypass valve for control of dynamic liquid temperature control. In case temperature of the dynamic liquid is too low, the temperature control valve can turn off the oil path so that the dynamic liquid cannot pass through the heat exchanger to keep lower temperature of the dynamic liquid. In case temperature of the dynamic liquid rises up to a certain value, the temperature control valve is activated to open the oil path to decrease temperature of the dynamic liquid through the heat exchanger to keep stable dynamic liquid temperature in the hydraulic torque converter for normal operation. The shortcoming of the existing technology is that the bypass valve to sense the temperature of dynamic liquid is far away from the hydraulic converter and cannot actually reflect temperature of the dynamic liquid so as to affect output of the hydraulic torque converter.

Thus, there exists a need for a hydraulic torque converter that is able to reflect the temperature of the dynamic liquid more accurately and improve operation compared to the prior art.

### SUMMARY OF THE INVENTION

The hydraulic torque converter with a temperature automatic regulator of dynamic liquid includes hydraulic torque converter and radiator. A temperature control valve is also included to reflect the temperature of the dynamic liquid. The hydraulic torque converter is provided with dynamic liquid outlet tube and dynamic liquid inlet tube. The dynamic liquid inlet tube and dynamic liquid outlet tube are connected with radiator. The temperature control valve is mounted at the end of dynamic liquid inlet tube and dynamic liquid outlet tube near the hydraulic torque converter.

The temperature control valve includes a valve body, a valve element, a, a piston rod seat and a piston rod. The valve element, spring and piston rod seat are mounted in the valve body. The middle hole of the valve element is provided with piston rod chamber. The thermosensitive rubber is mounted in the piston rod chamber. The piston rod is connected with the piston rod seat. The lower section of the piston rod is mounted in the piston rod chamber of the valve body and the lower section of the piston rod slides in the piston rod chamber. The lower end of the piston rod is contacted with end face of the thermosensitive rubber. The valve body is provided with valve body inlet and valve body outlet. The valve body inlet is connected with the dynamic liquid outlet tube of the hydraulic torque converter. The valve outlet is connected with the dynamic liquid outlet of the hydraulic torque converter.

### BRIEF DESCRIPTION OF THE DRAWING

FIG. 1 shows structure of an embodiment of an inventive.

### DETAILED DESCRIPTION OF THE PREFERRED EMBODIMENTS

The present invention has utility as hydraulic torque converter for improving the operation of a motor vehicle. The technical problem to be solved is to provide a hydraulic torque converter with automatic regulator of dynamic liquid temperature mounted at inlet and outlet of dynamic liquid near the hydraulic torque converter with the beneficial effect that the temperature control valve is mounted at the inlet and outlet tube ends near the hydraulic torque converter to directly sense temperature of dynamic liquid in the hydraulic torque converter to ensure normal operation of the hydraulic torque converter.

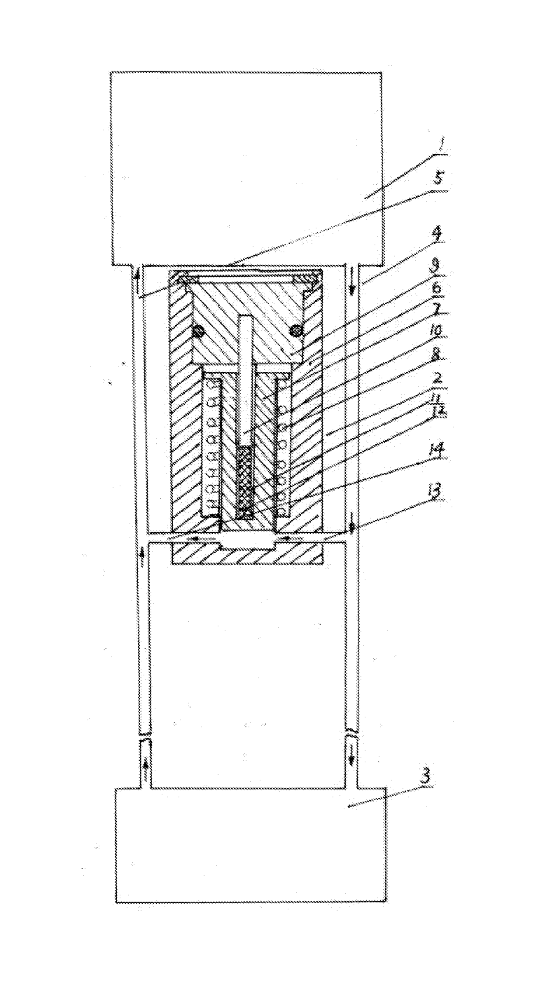

The problems associated with the prior art are solved with resort to a hydraulic torque converter, temperature control valve and radiator. The hydraulic torque converter is provided with a dynamic liquid outlet tube and a dynamic liquid inlet which are connected with the radiator. The temperature control valve is mounted at the inlet tube and outlet tube of dynamic liquid near the hydraulic torque converter. While the present invention is further detailed with respect to the relative directions of “upper” and “lower” relative to FIG. 1, it should be appreciated that the present invention is operative and intended to be claimed regardless of orientational frame of reference.

With respect to FIG. 1, a hydraulic torque converter is shown generally at 1. A temperature control valve 2; radiator 3; outlet tube of dynamic liquid 4; an inlet tube of dynamic liquid 5; a valve body 6; valve element 7; spring 8 such as a coil spring; piston rod seat 9; piston rod 10; piston rod chamber 11; thermosensitive rubber 12; valve body inlet 13; and valve body outlet 14 are provided and arranged as follows. The various components of an inventive hydraulic torque converter of formed of conventional materials for the various components thereof. While a coil spring is depicted in FIG. 1, it is appreciated that other types of springs are operative herein.

The temperature control valve 2 includes a valve body, a valve element, a spring, a piston rod seat and a piston rod. The valve element 7, spring 8 and piston rod seat 9 are mounted in the valve body 6. The spring 8 encompasses the valve element 7. The middle hole of the valve element is provided with a piston rod chamber 11 mounted with a thermosensitive rubber 12 therein. The piston rod 10 is connected with the piston rod seat 9. The lower section of the piston rod 10 is mounted in the piston rod chamber 11 of the valve body 6 and slides therein. The lower end of the piston rod 10 is contacted with the upper end face of the thermosensitive rubber 12. The valve body 6 is provided with an inlet and an outlet. The inlet of valve body 6 is in fluid communication with the dynamic liquid outlet tube 5 of the hydraulic torque converter 1. The outlet of the valve body is connected with the dynamic liquid inlet tube 4 of the hydraulic torque converter 1.

When the temperature of the dynamic liquid is too low, the thermosensitive rubber 12 in the valve element 7 senses the temperature of the dynamic liquid by decreasing in volume so that the valve element 7 moves up and down under the action of the force of the spring 8 to connect the inlet with the outlet of the valve body. The dynamic liquid of the hydraulic torque converter 1 can then directly return to the hydraulic torque converter from the dynamic liquid outlet tube 5 through the valve body inlet and valve body outlet of the temperature control valve 2 and the dynamic liquid inlet tube 4 instead of the radiator to keep lower temperature. In situations when the temperature of the dynamic liquid is too high, the thermosensitive rubber 12 in the valve element 7 can senses the high temperature of the dynamic liquid through an increase in the volume so that the liquid can move the valve element 7 to the lower position. In this case, the valve element 7 can turn off the passageway between the inlet and outlet of the valve body 6 to resist return of dynamic liquid in the hydraulic torque converter 1 through the temperature control valve 2. In this case, the dynamic liquid flows into the radiator 3 from the outlet. After temperature of the dynamic liquid is reduced by the radiator, it returns to the hydraulic torque converter 1 from inlet tube 4 of the dynamic liquid to keep lower temperature to ensure normal operation of the hydraulic torque converter 1.

A specific embodiment of the present invention includes hydraulic torque converter 1, temperature control valve 2 and radiator 3. The hydraulic torque converter 1 is provided with dynamic liquid outlet tube 4 and dynamic liquid inlet tube 5. The inlet tube 5 and outlet tube 4 are connected with the radiator 3. The temperature control valve 2 is mounted at the end of dynamic liquid inlet tube 5 and dynamic liquid outlet tube 4 of the hydraulic torque converter 1.

The temperature control valve 2 includes valve body 6, valve element 7, spring 8, piston rod seat 9 and piston rod 10. The valve element 7, spring 8 and piston rod seat 9 are mounted in the valve body 6. The middle hole of valve element 7 is provided with piston rod chamber 11. The thermosensitive rubber 12 is mounted in the piston rod chamber 11. The piston rod 10 is connected with the piston rod seat 9. The lower section of the piston rod 10 is mounted in the piston rod chamber 11 of the valve body 6 and can slide in it. The lower end of the piston rod 10 is contacted with end face of the thermosensitive rubber 12. The valve body 6 is provided with valve body inlet 13 and valve body outlet 14. The valve body inlet 13 is connected with dynamic liquid outlet tube 4 of the hydraulic torque converter 1. The valve outlet 14 is connected with dynamic liquid inlet tube 5 of the hydraulic torque converter 1. Exemplary thermosensitive rubbers operative herein include styrene butadiene rubber, natural rubber, and silicone rubbers; a filled forms of any of the aforementioned rubbers where fillers illustratively include carbon black.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A hydraulic torque converter with an automatic temperature regulator of dynamic liquid when coupled to a radiator, said hydraulic torque converter comprising:
a dynamic liquid outlet tube in fluid communication with the radiator;
a dynamic liquid inlet tube in fluid communication with the radiator;
a piston rod chamber receiving a piston rod;
a temperature control valve mounted at an inlet end of said dynamic liquid inlet tube and an outlet end dynamic liquid outlet tube, said temperature control valve comprising: a valve body having a valve body inlet and a valve body outlet, the valve outlet in fluid communication with said dynamic liquid outlet; a valve element having a middle hole ; a spring; a piston rod seat engaging said piston rod; and thermosensitive rubber mounted in said piston rod chamber;
a lower section of said piston rod slidably mounted in the piston rod chamber with a lower end of said piston rod contacting said thermosensitive rubber changing volume as a function of temperature of the dynamic liquid to control flow through a valve body inlet and a valve body outlet as a function of temperature of the dynamic liquid.

2. The converter of claim 1 wherein said thermosensitive rubber is one of styrene butadiene rubber, natural rubber, or silicone rubber.

3. The converter of claim 1 wherein the valve body inlet and the valve body outlet pass through said valve element.

4. The converter of claim 3 wherein said thermosensitive rubber expands when the dynamic fluid has a temperature greater than a preselected threshold to prevent flow of the dynamic fluid from the valve body inlet and the valve body outlet through said valve element.

5. The converter of claim 1 wherein said spring encompasses said valve element.
